(19) United States
(12) Patent Application Publication
(10) Pub. No.: US 2006/0118488 A1
(43) Pub. Date: Jun. 8, 2006

(54) Apparatus and method of utilizing a sawed tooth shaped gradient for chromatographic separation

(75) Inventors: Aaron T. Timperman, Morgantown, WV (US); Daniel L. Morris, Morgantown, WV (US)

Correspondence Address: SONNENSCHEIN NATH & ROSENTHAL LLP;FOR PAULA EVANS, P.O. BOX 061080, WACKER DRIVE STATION, SEARS TOWER, CHICAGO, IL, 60606-1080, US

(73) Assignee: West Virginia University Research Corporation

(21) Appl. No.: 11/153,862

(22) Filed: Jun. 15, 2005

Related U.S. Application Data
(60) Provisional application No. 60/579,892, filed on Jun. 15, 2004.

(51) Int. Cl. B01D 15/08

(52) U.S. Cl. 210/656; 210/198.2; 436/161

(57) ABSTRACT

The present invention provides an apparatus and a method wherein the movement of analytes on a chromatographic separation column is controlled by the manipulation of isocratic and gradient flow. Such manipulation allows for a distinct set of analytes to be eluted from the chromatography column and delivered downstream for further separation and/or processing while the remainder of the sample remains in a “holding pattern” on the chromatography column. As such, the present invention allows for a small portion of the sample to be processed downstream of the column while substantially eliminating undesirable isocratic elution from the column during such downstream processing. Once the downstream processing has been completed, the column of the present invention elutes a second distinct analyte and the remainder of the sample is maintained in a holding pattern. The process may be repeated until the entire sample has been eluted from the chromatography column.

### RELATED APPLICATIONS

This application claims the benefit of U.S. Provisional Application Ser. No. 60/579,892, filed on Jun. 15, 2004. The entire teachings of the above application is incorporated herein by reference.

### GOVERNMENT SUPPORT

None.

### FIELD OF THE INVENTION

The present invention relates to field of chromatography; more specifically, the present invention relates to the use of gradient and isocratic flow to control elution from a chromatographic separation column.

### BACKGROUND

Proteomics is a vast field which will provide the enabling technologies and methodologies required to improve our understanding of the underlying cell and molecular biology of living systems. This knowledge will be relevant to diagnosis and prognosis of numerous diseases and clinical conditions, such as cancer and diabetes, which will require proteome profiling. Proteomics is being applied to drug discovery to understand interactions of small molecules with proteins, and how small molecules affect the entire biological system. However, the complexity of proteomes makes their analysis extraordinarily challenging and will require large improvements in the analytical technologies used for proteome analysis. The complexity of a proteome arises from: the proteome's numerous protein components which can number in the tens of thousands, the wide variety of post-translational modifications that can regulate a protein's activity, the wide and varying range of relative abundance of these compounds, and the dynamic nature of a proteome that changes as protein expression changes. Moreover, the proteins of greatest interest are often the signaling proteins that are present at very low relative abundance.

An example of a clinically relevant and complicated proteome is human serum. Recent work includes the separation and characterization of lipoproteins from human serum as markers for coronary heart disease and atherosclerosis and the profiling of proteomic patterns in low molecular weight serum in differentiating between healthy patients and those with ovarian cancer. However, the human serum proteome is still largely unclassified. Serum contains an estimated 10,000 different proteins with concentrations ranging over 9 orders of magnitude. While separation of a mixture of this complexity is a challenging endeavor in itself, the task is made even more daunting as only about 10 proteins comprise about 90% of the total protein content in serum. One protein, Human Serum Albumin (“HSA”), makes up more than 50% of the entire serum proteome and masks other less abundant proteins. Such extremely high levels of protein expression requires superior separation techniques in order to further characterize the human serum proteome.

Two-dimensional gel electrophoresis (“2DE”) is used routinely for analyzing such protein samples, although it has many limitations. The greatest limitation of 2DE is its low peak capacity, which prohibits the analysis of low abundance proteins from the gels in comprehensive proteome analysis. Although it has a two-dimensional separation and peak capacities on the order of about 4,000 are common, the complexity of whole proteomes requires higher peak capacities for the analysis of low abundance proteins. Staining of the gels allows detection of the proteins, but this method provides very little quantitative information and no structural information. Proteins can be identified directly from stained gels by performing an in-gel digestion followed by mass spectrometric analysis of the resulting peptides.

Tandem mass spectrometry (“MS/MS”) is frequently used for peptide identification from the gels through acquisition of the collision induced dissociation or fragment ion spectra. The in-gel proteolytic digestions are slow, and extraction of the peptides also varies while the gel matrix adds chemical noise to the extracted peptide solution. Furthermore, electroelution of whole proteins from stained gels is unreliable and therefore is not used for the separation of proteins and extraction of whole proteins for top-down proteomic approaches. In total, processing the gels and acquiring MS data can take several days to several weeks for a given sample. Using gels it is also difficult to identify extremely acidic or basic, or very high and low mass proteins, because they are often underrepresented or absent from the gel. While 2DE has provided an excellent starting point for proteomics analysis, the many limitations reduce its future utility.

Two basic approaches to the analysis of complex proteomic samples have been developed. The first method is the traditional method in which the protein mixture is separated, before the enzymatic digestion is performed. The second method, which is commonly referred to as multi-dimensional protein identification technology (“MuDPIT”) or “shot-gun sequencing” begins with proteolytic digestion of the complex protein mixture, followed by separation of the peptide mixture with even greater complexity.

Shot-gun sequencing is capable of identifying many proteins in comprehensive analyses because performing the digest before the separation eliminates the difficulties associated with the separation of proteins with extreme pK values and sizes. This approach makes it easier to identify many of the proteins that are difficult to solubize and separate as whole proteins. The protein digests are separated using strong cation exchange (“SCX”) as the first dimension and reversed phase high performance liquid chromatography (“RP-HPLC”) as the second dimension with MS detection. Variations of this approach include a method in which affinity adsorption chromatography was used to reduce the levels of immunoglobulins in human serum followed by trypsin digestion, ion exchange chromatography (“IEC”) and HPLC of the digest. Serum protein digests were also separated using a novel ampholyte free isoelectric focusing approach followed by reversed-phase microcapillary LC of the peptides. Complications associated with the above procedures are the complexity of the protease digest, the large range of protein abundance and the post-translational modifications that are typical of these samples.

Alternative methods to 2DE of whole protein separations are also being developed, and many improvements have been made with alternative multi-dimensional protein separation strategies. It is possible to achieve successful separation of whole proteins using multidimensional techniques incorporating RP-HPLC. Gel-free separation modes that are often used in multi-dimensional protein separation approaches include: reversed-phase (“RP”), ion exchange chromatography (“IEC”), size exclusion chromatography (“SEC”), capillary electrophoresis (“CE”) and isoelectric focusing (“IEF”).

Recently, 2-dimensional separations employing capillary electrophoresis on microfluidic devices have been reported. The advantages that result from CE performed on electrophoretic microchips are well known. In addition to their small sample size requirements, short analysis times and high resolving power, new functionalities can be added to microfluidic devices, such as reactions to prepare samples for subsequent analysis. CE is a reasonable choice for the final step of a multi-dimensional separation followed by MS detection because it is an exceptionally powerful separation technique capable of providing superior resolution for very complex samples in short amounts of time, and its operating characteristics are very compatible with nano-scale electrospray ionization mass spectrometry (ESI-MS). Several choices exist for the separation upstream of the CE interface. In order to reap the maximum benefits from a 2D separation, the separation mechanisms must be orthogonal to one another, separating the molecules based on unrelated properties. RP-HPLC is an excellent choice for a separation preceding a CE separation because it is highly orthogonal separating on the basis of hydrophobicity, requires compatible solvent systems, and is capable of achieving high peak capacities. As such, there is a need in the art for an apparatus and method for performing RP-HPLC so that separated analytes may be eluted from a chromatography column and delivered downstream for further separation and/or processing while keeping the remainder of the sample on the column and substantially eliminating any undesirable elution from the column. Such an apparatus and method would simplify the microfluidic analysis because only a small portion of the sample (i.e., a purified analyte) would be eluted from the column at a time and a second analyte would only be eluted from the column once the first microfluidic analysis was completed. Further, there is a need in the art to perform such a process while maintaining high quality results.

### SUMMARY OF THE INVENTION

The present invention provides an apparatus and method for the purification and/or separation of analytes from a sample. More specifically, the present invention provides an apparatus and a method wherein the movement of analytes on a chromatographic separation column is controlled by the manipulation of isocratic and gradient flow. Such manipulation allows for a distinct set of analytes to be eluted from the chromatography column and delivered downstream for further separation and/or processing while the remainder of the sample remains in a “holding pattern” on the chromatography column. As such, the present invention allows for a small portion of the sample to be processed downstream of the column while substantially eliminating undesirable isocratic elution from the column during such downstream processing. Once the downstream processing has been completed, the column of the present invention elutes a second distinct analyte and the remainder of the sample is maintained in a holding pattern. The process may be repeated until the entire sample has been eluted from the chromatography column.

In a preferred embodiment of the present invention, a chromatographic separation column is provided utilizing a gradient mobile phase. In a preferred embodiment, the mobile phase comprises at least a first component and a second component. In a preferred embodiment, a concentration of the first component is gradually increased allowing a portion of the sample to be eluted from the chromatographic separation column. After the purified analyte has been eluted from the column, the concentration of the first component is reduced to substantially eliminate further elution from the column. In a preferred embodiment of the present invention, a single analyte is eluted from the column and undergoes a downstream processing step before a second analyte is eluted from the chromatography column. In one embodiment, the cycle is repeated until the entire sample has been eluted from the chromatography column.

In a preferred embodiment of the present invention, the chromatographic separation column is engaged to a microfluidic device via an output channel. In a preferred embodiment, the present invention allows an analyte to be eluted from the chromatographic separation column while the remainder of the sample remains in the chromatographic separation column. In a preferred embodiment of the present invention, the chromatography column is coupled to a capillary electrophoresis device. Those skilled in the art will recognize that various downstream processes are within spirit and scope of the present invention.

In a preferred embodiment, the separation occurs by reversed-phased high performance liquid chromatography. In another embodiment, the separation occurs by size-exclusion chromatography. In another embodiment, the separation occurs through high performance liquid chromatography. In another embodiment of the present invention, the separation occurs by ion exchange chromatography. In another embodiment, the separation occurs by chromatic focusing. In another embodiment, the separation occurs by hydrophobic interaction chromatography.

The present invention also discloses a method of separating an analyte comprising delivering a sample to an inlet channel of a chromatographic separation column, providing a main channel engaged to the inlet channel of the chromatographic separation column, delivering a mobile phase through the main channel wherein the mobile phase comprises at least a first component and a second component, increasing a concentration of the first component to provide gradient flow, and subsequently, reducing the concentration of the first component to substantially prevent further elution from the chromatographic separation column.

As such, the apparatus and method of the present invention provides for increased control over the elution of purified analytes from a chromatography column. Such control allows for more precise downstream analysis and/or derivitazation. In addition, such control substantially prevents undesirable elution from the chromatography column.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention.

FIG. 1 shows a chromatogram of a sample separated using a linear gradient of the prior art wherein the gradient profile is superimposed.

FIG. 2A shows a chromatogram of a sample separated using a stepwise gradient of the prior art wherein the gradient profile has been superimposed. FIG. 2B shows a chromatogram of a sample separated using a saw tooth gradient of the present invention.

FIG. 3 shows a chromatogram of a sample using a linear gradient of the prior art wherein a gradient profile is superimposed.

FIG. 4A shows a chromatogram of a sample using a stepwise gradient of the prior art wherein a gradient is superimposed. FIG. 4B shows a chromatogram of a sample separated using a saw tooth gradient of the present invention wherein a gradient profile is superimposed.

FIG. 5A and FIG. 5B show a comparison of a sample separated using a linear gradient of the prior art and a saw tooth gradient of the present invention. FIG. 5A shows the 7 minute to 23 minute portion of the linear gradient. FIG. 5B shows the 23 minute to 35 minute portion of the linear gradient. The time scales correspond to the linear gradient, and corresponding peaks from a saw tooth gradient of the present invention are superimposed.

While the above-identified drawings set forth preferred embodiments of the present invention, other embodiments of the present invention are also contemplated, as noted in the discussion. This disclosure presents illustrative embodiments of the present invention by way of representation and not limitation. Numerous other modifications and embodiments can be devised by those skilled in the art which fall within the scope and sprit of the principles of the present invention.

### DETAILED DESCRIPTION

The present invention provides a gradient profile for separating whole proteins that allows for the injection of small protein “packets” into a downstream microfluidic device for further capillary electrophoresis (“CE”) separation or other processing. The saw-tooth gradient profile of the present invention incorporates a delay in which flow is maintained without eluting more proteins. The novel saw tooth gradient of the present invention provides results comparable to a linear gradient profile with the added benefit that a portion of the sample may be eluted from the column while the remainder of the sample may be maintained on the chromatography column-the ability to elute only a portion at time provides for higher quality and more efficient downstream processing.

The novel saw-tooth gradient profile is created by providing a mobile phase comprising at least a first component and a second component, increasing the concentration of the first component to allow for the elution of a portion of the sample, and subsequently decreasing the concentration of the first component. Decreasing the concentration of the first component provides better control over the elution of analytes as opposed to keeping the concentration of the first component constant once a desired concentration has been reached—such a gradient profile leads undesirable loss and poor results during the time period where the concentration is kept constant. Incorporation of this delay by the present invention allows for subsequent CE separations and higher quality sample processing reactions on a microfluidic chip. The downstream results are better because only a small portion of the sample is processed as opposed to the entire sample. Additionally, reversed-phase high performance liquid chromatography (“RP-HPLC”) and CE separations can be performed in series, which alleviates the need for complex instrumentation. In addition, the gradient of the present invention allows for the above delay without introducing extra-column broadening of a sample band delivered to the microfluidic device.

The apparatus and method of the present invention comprise a novel saw tooth gradient for reversed phase high performance liquid chromatography, which allows small subsets of a complex sample to be eluted from the column and processed for further analysis in real time. Performing reversed-phase high performance liquid chromatography separation by the apparatus and method of the present invention makes it possible to perform downstream processing, including additional separation dimensions, on eluted protein fractions without a loss of peak capacity or an increase in band broadening. The saw tooth gradient of the present invention allows subsets of proteins to be collected from very complicated samples, thereby decreasing the complexity of digests that may be subsequently analyzed using MS. The saw tooth gradient of the present invention also eases the instrumental requirements for downstream separation and processing of eluted proteins by allowing the separation to be performed in a serial manner.

In order to better disclose the apparatus and method of the present invention, the following experiments were performed:

Experimental

Separations were performed on an Agilent (Wilmington, Del., USA) 110 Series high performance liquid chromatography system equipped with a binary pump, column oven, and diode array detector with a 6 mm/5 μL micro flow cell. Data acquisition and processing were controlled using Chemstation software. Injections were performed manually using a Rheodyne 7725 injector (Rohnert, Calif., USA) with 20 μL sample loop. A non-porous silica based polymerically bonded ODS column (3.3 cm×3.0 mm) with 1.5 μL diameter packing particles (Eichrom, Darien, Ill., USA) was used. Separations were performed at 60.0° C. at a flow rate of 0.200 mL/min. Chromatograms were obtained using UV absorption at 210 nm.

Mobile phases A and B each contained 0.1% (VN) acetic acid and 0.05% (V/V) of the ion pairing agent HFBA. Acetonitrile was used as the organic modifier (55 V/V in mobile phase A and 70% V/V in mobile phase B). A linear gradient profile, a segmented stepwise gradient profile, and saw tooth gradient profile were employed to illustrate the benefits of the saw tooth gradient profile of the present invention.

The linear gradient profile increased the percentage of at least one component of the mobile phase, solvent B, from 0% to 100% over a 40 minute period (increased at a rate of 2.5% per minute) and was held at 25% for 9 minutes.

In the stepwise gradient profile, the percentage of solvent B was increased in increments of 5% until a value of 35% was reached. The increment was increased to 10% until the percentage of B reached 75%. The rate of change for each increment was 2.5% per minute, and each segments was separated by 9 minutes during which isocratic conditions were maintained. The percentage of B was increased from 75% to 100% B over 5 minutes, and dropped to 0% over another 5 minute period (total time approximately equal to 117 minutes).

The saw tooth gradient increased the percentage of B from 0 to 25% over 10 minutes (2.5% per minute) followed by a decrease of 5% to a composition of 20% B over 3 minutes. The percentage of B was held at 20% for 6 minutes. The percentage of B was increased from 20 to 30% at the same rate of 2.5% per minute followed by a 5% decrease to 25%. The composition remained at 25% for 6 minutes. The cycle was repeated in the following increments: 25 to 35 to 30 % B; 30 to 45 to 40% B; 40 to 55 to 50% B; 50 to 65 to 60% B; and 60 to 75 to 70% B. The rate at which the percentage of B was increased was kept constant at 2.5% per minute. The composition was increased from 70 to 100% B in 5 minutes, held at 100% B for 5 minutes,, and decreased to O% B in 5 minutes (total time was about 120 minutes.)

Samples were prepared from normal human serum. Briefly, a 1 mL aliquot of whole serum was divided into 200 μL aliquots and denatured by adding 120 μL of 80/20 (V/V) water/acetonitrile to each aliquot and heating to 40° C. for 15 minutes. The samples were centrifuged to separate the supernatant from insoluble material. A portion of one of these aliquots was diluted 100 fold in mobile phase A for the whole serum studies. Low molecular weight fractions (<30 kDa) were collected from these aliquots using 30 kDa molecular weight cutoff centrifugal spin filters (Microcon) conditioned with 0.1 NaOH and washed with water. The denaturing conditions used for preparing the serum minimize the loss of low molecular weight proteins that may stick to albumin. The filtrates from each aliquot were combined, lyophilized to dryness, and resuspended in 100 μL of water. Water blanks were injected prior to each sample, and blank runs were subtracted from sample chromatograms using Chemstation software.

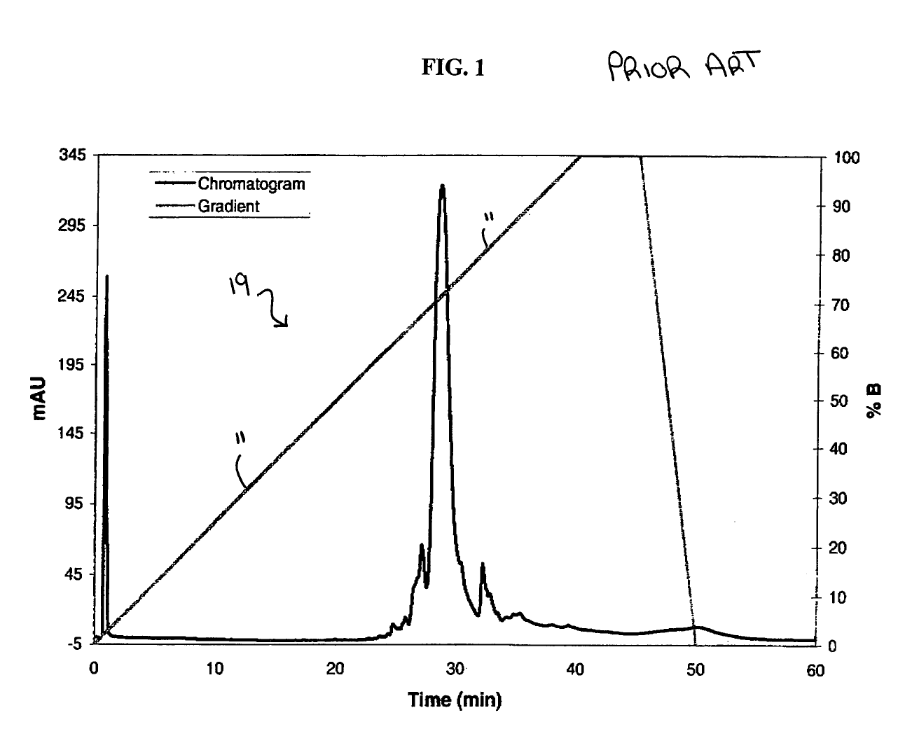

The chromatograms shown in FIG. 1 through FIG. 5B were obtained using the experimental conditions set forth above. The experiments and chromatograms discussed in these FIGS. are merely to better demonstrate and describe the present invention and are by no means intended to limit the use of the invention to those samples used in the experiments. Those skilled in the art will recognize that many samples and/or experimental conditions are within the spirit and scope of the present invention.

The following discussion of the chromatograms shows the differences between the prior art use of a linear gradient profile, the prior art use of a step-wise gradient profile and the saw-tooth gradient of the present invention. Each of the gradient profiles were created as follows: A mobile phase is used wherein the mobile phase comprises at least a first component and a second component. A linear gradient profile is created when the composition of the first component is continually increased. A step-wise gradient profile is created when the composition of the first component is first increased to a desired concentration and then held constant. Such a profile combines gradient flow and isocratic flow. Using isocratic flow to prevent further elution is not ideal because analytes tend to continue to elute during the isocratic region of the profile. The present invention improves upon above discussed profiles by increasing the composition of the first component to a desired concentration and subsequently decreasing the concentration of the first component (as opposed to merely keeping the concentration of the first component constant). Such a novel gradient profile substantially eliminates undesirable elution from the column which allows a small portion of the sample to be eluted from the column in a controlled manner.

FIG. 1 shows a chromatogram of ultracentrifuged whole serum (1:100 dilution) separated using a linear gradient 19 of the prior art. The gradient profile is superimposed above the chromatogram. The superimposed gradient profile is a gradient with a constant positive slope 11. As discussed above, such a gradient profile is created by constantly increasing the concentration of the first component of the mobile phase. More specifically, the linear gradient program increases the volume percentage of mobile phase B by 2.5% per minute until a composition of 100% mobile phase B is reached at 40 minutes. The chromatogram of the whole serum sample is dominated by a large peak at 29 minutes attributed to human serum albumin (“HSA”). While several other peaks are still visible in this region despite the large width of the HSA peak, 99% of the total protein content in serum is comprised of only 22 proteins, and 50% of the total protein content is attributed to HSA.

Previous work has been performed on human serum that does not involve prior removal of albumin relies on chromatographic fractionation of the serum digest peptides to overcome the large range in protein abundance. For the case of whole proteins, however, it is clear that further separation and processing must take place downstream of a given HPLC separation to overcome the complications of overlapping peaks and wide protein abundance ranges in proteome analysis. A linear gradient profile does not allow for a portion of the sample to be eluted while maintaining the remainder of the sample on the column. As such, a linear gradient profile does not allow for an analyte to be delivered downstream to a microfluidic device in such a controlled manner as evidenced by the profile of the present invention.

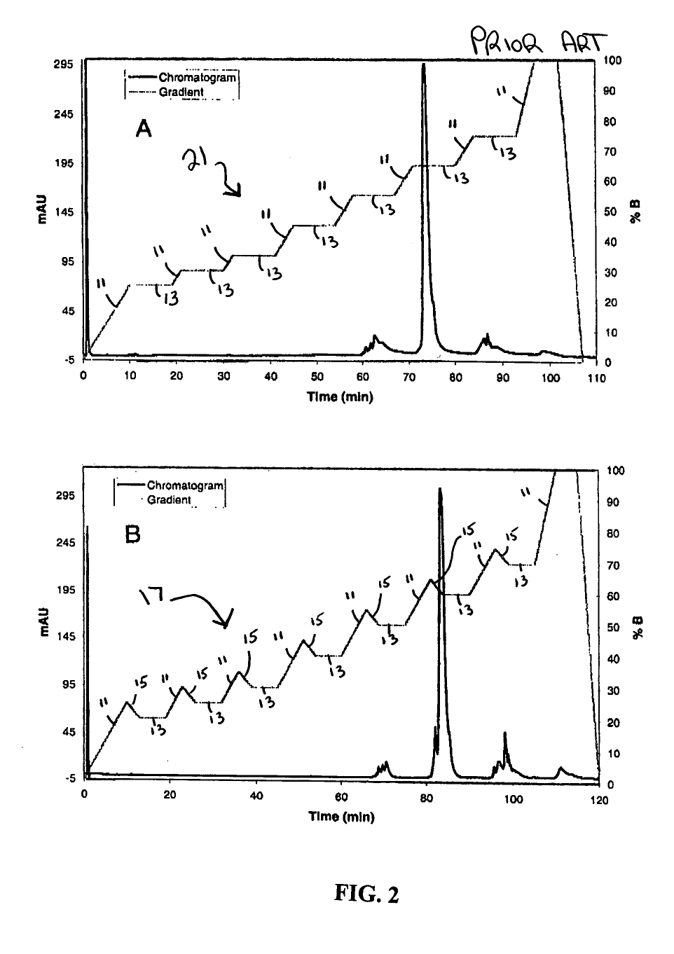

FIG. 2A shows a segmented stepwise gradient profile 21 in which the percentage of mobile phase B was increase at 2.5% per minute (identical to the linear gradient) for anywhere from 2 to 4 minutes followed by isocratic regions of 9 minutes in duration to allow for downstream processing of the proteins eluted during the gradient region 11. As stated above, such a profile is created by constantly increasing the concentration of a first component of the mobile phase thus creating a gradient profile with a positive slope 11. Once a desirable concentration of the first component has been reached, the concentration is held constant 13. This region of isocratic flow 13 has been used to limit elution from the column. FIG. 2A represents a segmented stepwise gradient profile 21 because the typical stepwise gradient 21 increases the percentage of a first component of the mobile phase in sharp, discrete steps rather than the more gradual 2.5% per minute rate employed by the present apparatus and method. For simplicity, the specification will refer to the gradient profile illustrated by FIG. 2A as “stepwise”.

When the chromatogram resulting from the stepwise gradient 21 (as seen in FIG. 2A) is compared to that produced by the linear gradient (as seen in FIG. 1), it is clear that the quality of the separation suffers from the stepwise approach 21. The isocratic regions 13 (the approximately flat regions) in the stepwise gradient 21 introduced significant isocratic elution of peaks eluting near the end of each gradient interval 11, resulting in significant band broadening to the point where many peaks in the isocratic region 13 would either not be loaded for a second dimension separation or be so broad as to be undetectable. The present invention discloses an apparatus and method capable of substantially eliminating undesirable elution while not incorporating the above-discussed problems of band broadening into the process.

To prevent the isocratic elution between gradient steps, the present invention introduces a small gradient segment with a negative slope 15 after each positive gradient 11 segment in which a subset of proteins was eluted. This “saw tooth” gradient 17 provides the ability to perform a separation in a stepwise fashion, maintain isocratic conditions 13 for processing samples downstream from the LC separation, and eliminate the band broadening observed using a stepwise gradient. It is comparable to the linear and stepwise gradients in that the percentage of mobile phase B is changed at a rate of 2.5% per minute over 2 to 4 minute intervals separated by 6 minute isocratic conditions.

FIG. 2B shows the chromatogram of whole serum separated using the saw tooth gradient 17. The saw tooth gradient 17 allows the smaller peaks to be isolated effectively from the large HSA peak and minimizes the problem of band broadening during the isocratic portion 13 of the gradient profile as encountered when using the step-wise gradient profile 21. This allows the option of collecting less abundant proteins as fractions or processing then on-line in a second separation dimension.

Selective removal of albumin and other high abundance proteins makes the analysis of whole proteins in serum more feasible when combined with multidimensional separations. Albumin and other high abundance proteins may be removed from serum by immunoaffinity subtraction chromatography. The remaining proteins may then be fractionated using a combination of ion exchange chromatography and size exclusion chromatography followed by 2D gel electrophoresis. In another embodiment, albumin was removed by a preparative electrophoresis system (Gradiflow) by isolating it from other proteins on the basis pI followed by further isolation using size restriction membranes. The remaining proteins were separated using 2D gel electrophoresis. Centrifugal ultrafiltration techniques for isolating the low molecular weight components of human serum show promise in the detection and identification of the less abundant proteins. The filters allow renewal of albumin and other high molecular weight components and enrichment of the less abundant low molecular weight species. Performing the ultrafiltration step under denaturing conditions disrupts protein-protein interactions and minimizes the loss of low abundance species that may otherwise be captured by carrier proteins like albumin. The results from these various studies of human serum are complimentary and when combined, result in a nonredundant list of proteins that helps to characterize further the human plasma proteome.

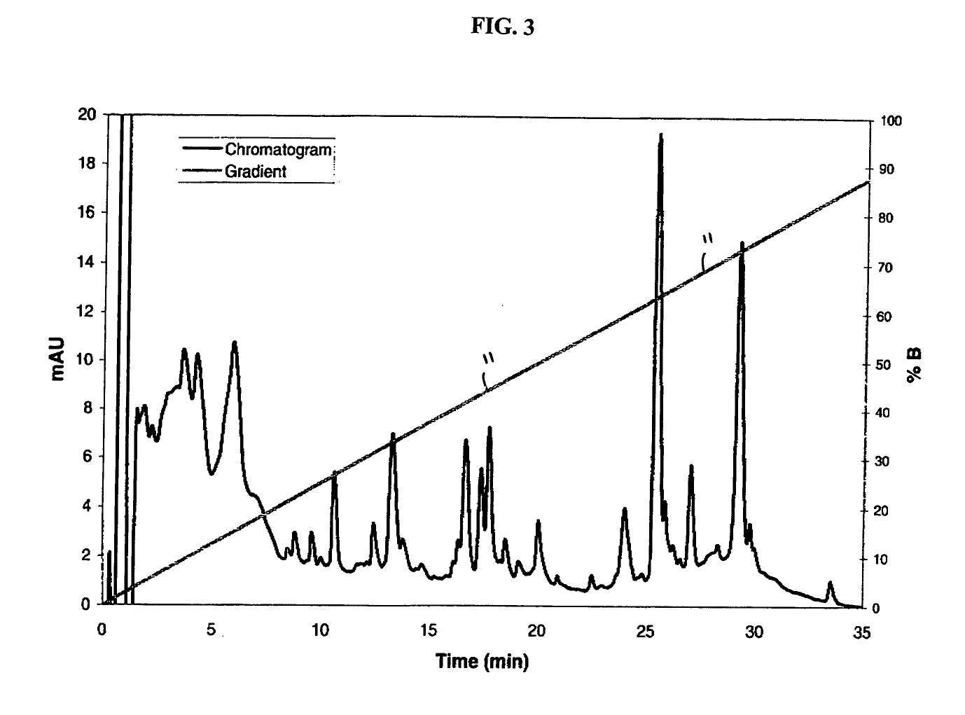

FIG. 3 shows a chromatogram of the low molecular weight fraction of human serum isolated using a linear gradient 19. The linear gradient 19 appears to provide adequate separation of the proteins in the low molecular weight human serum fraction. However, a second separation dimension is required to resolve overlapping peaks and characterize the sample fully. Also, the linear gradient 19 does not allow for a portion of the sample to be eluted from the chromatography column and be processed downstream while retaining remainder of the sample on the chromatography column. Those skilled in the art will recognize that various downstream processes are within spirit and scope of the present invention.

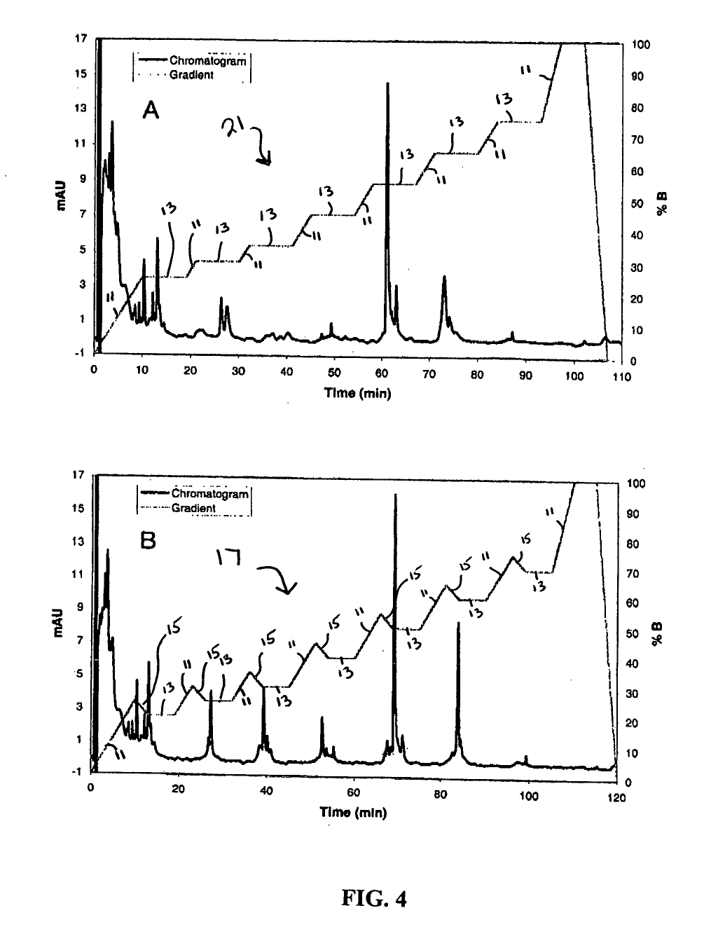

FIG. 4A shows a chromatogram of the low molecular weight serum sample separated using a stepwise gradient 21. The chromatogram exhibits significant band broadening and is inferior to the results obtained using a linear gradient. The problem of significant band broadening has been substantially improved by the use of the saw tooth gradient of the present invention.

FIG. 4B shows the low molecular weight fraction serum sample separated using the saw tooth gradient 17 of the present invention. The saw tooth gradient 17 of the present invention provides superior resolution when compared to the chromatogram obtained via the stepwise gradient as seen in FIG. 4A.

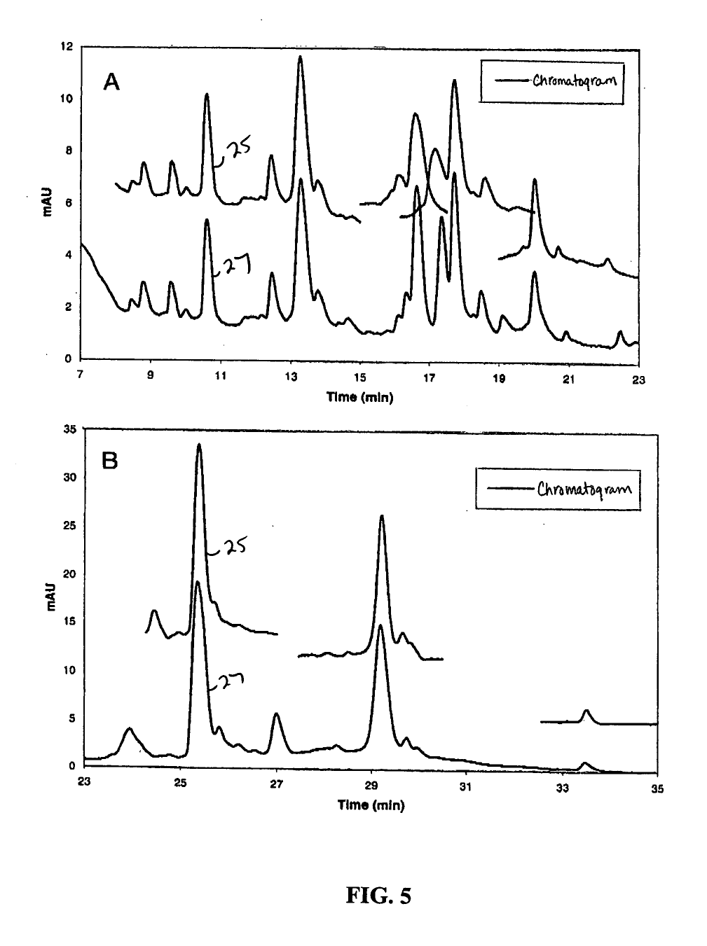

FIG. 5 shows a direct comparison of the separation of low molecular weight human serum using the linear gradient 19 versus the same separation obtained using the saw tooth gradient 17 of the present invention. To facilitate the comparison, FIG. 5A shows the chromatogram from the 7 minute mark to the 23 minute mark. FIG. 5B shows the results of the separation from the 23 minute mark to the 35 minute mark.

The comparison between the saw tooth chromatogram 25 and the linear chromatogram 27, as shown FIG. 5A and FIG. 5B, indicate that the saw tooth gradient 17 does not introduce a significant amount of band broadening and does not compromise resolution or sensitivity when compared to the separation using the linear gradient 19. If necessary, the time periods over which isocratic portions 13 of the gradient program are maintained can be extended without introducing significant band broadening. Therefore, the saw tooth gradient 17 of the present invention makes it possible to insert “holding” segments into the gradient during which down-stream processing, such as additional separation diminution and/or a proteolytic digestion, can be performed. Because a second or third dimension of separation can be performed in a serial manner, the instrumental demands for additional dimensions of separation are minimized. Furthermore, time can be allowed to perform more complex sample preparation on a microfluidic chip.

All patents, patent applications, and published references cited herein are hereby incorporated by reference in their entirety. While this invention has been particularly shown and described with references to preferred embodiments thereof, it will be understood by those skilled in the art that various changes in form and details may be made therein without departing from the scope of the invention encompassed by the appended claims.

What is claimed is:

1. A chromatographic separation column comprising:
an inlet channel;
a main channel engaging the inlet channel; and
a mobile phase in communication with the main channel wherein the mobile phase comprises at least a first component and a second component,
wherein a concentration of the first component in the mobile phase is initially increased by a first amount and subsequently decreased by less than the first amount so as to provide a gradient with an initially positive slope followed by a gradient with a negative slope.

2. The device of claim 1 further comprising an output channel.

3. The device of claim 2 further comprising a microfluidic device engaging the output channel.

4. The device of claim 1 wherein the main channel further comprises a stationary phase.

5. The device of claim 4 wherein the stationary phase is polar.

6. The device of claim 5 wherein the stationary phase is non-polar.

7. The device of claim 1 wherein the main channel further comprises a plurality of particles to allow for size-exclusion chromatography.

8. The device of claim 1 wherein the decrease in the concentration of the first component substantially eliminates elution from the chromatographic separation column.

9. A method of separating an analyte comprising:
delivering a sample to an inlet channel of a chromatographic separation column;
providing a main channel engaged to the inlet channel of the chromatographic separation column;
delivering a mobile phase through the main channel wherein the mobile phase comprises at least a first component and a second component;
increasing a concentration of the first component to provide gradient flow; and
reducing the concentration of the first component to substantially prevent further elution from the chromatographic separation column.

10. The method of claim 9 wherein the concentration of the first component is repeatedly increased and subsequently decreased.

11. The method of claim 9 wherein the main channel is further engaged to an output channel.

12. The method of claim 11 wherein the output channel is engaged to a microfluidic device.

13. The method of claim 9 wherein the main channel comprises a stationary phase.

14. The method of claim 13 wherein the stationary phase is polar.

15. The method of claim 9 further comprising providing a plurality of particles in the main channel to allow for size-exclusion chromatography.

16. A method of delivering a substantially purified analyte to a microfluidic device comprising:
delivering a sample to an inlet channel of a chromatographic separation column;
providing a main channel engaged to the inlet channel of a chromatographic separation column;
delivering a mobile phase through the main channel wherein the mobile phase comprises at least a first component and a second component;
increasing a concentration of the first component wherein such an increase allows a portion of the sample to elute from the chromatographic separation column; and
decreasing the concentration of the first component to substantially prevent further elution from the chromatographic separation column.

17. The method of claim 16 further comprising increasing the concentration of the first component a second time to allow a second analyte to elute from the chromatographic separation column.

18. The method of claim 17 further comprising decreasing the concentration of the first component to prevent elution from the chromatographic separation column.

19. The method of claim 16 wherein the main channel further comprises a stationary phase.

20. The method of claim 16 wherein the main channel comprises a plurality of particles to allow for size-exclusion chromatography.
